(19) United States
(12) Patent Application Publication
(10) Pub. No.: US 2005/0006889 A1
(43) Pub. Date: Jan. 13, 2005

(54) Safety steering column for a motor vehicle

(76) Inventors: Christian Born, Hamburg (DE); Florian Senkpiel, Sittensen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/487,419

(22) PCT Filed: Jun. 7, 2002
(86) PCT No.: PCT/EP02/06252

(30) Foreign Application Priority Data
Aug. 22, 2001 (DE) 101410786

(51) Int. Cl. B62D 1/19

(52) U.S. Cl. 280/777

(57) ABSTRACT

The invention relates to a safety steering column for a motor vehicle, with a column tube which is arranged concentrically to a steering spindle and is fastened to the vehicle body and which, during an axial impact action, can be shortened, while absorbing energy, and at the same time cooperates with at least one energy absorption element. According to the invention, the at least one energy absorption element is a chip removal element which, in the event of a relative movement of the column tube with respect to the vehicle body, caused by the axial impact action, breaks down energy by chip removal.

### BACKGROUND OF THE INVENTION

The present invention relates to a safety steering column for a motor vehicle comprising a column tube arranged concentrically to a steering spindle and operatively connected to the vehicle body to be shortenable during an axial impact while absorbing energy, and at least one energy absorption element operatively cooperating with the column tube, the at least one energy absorption element being a least one chip removal element which, in the event of relative movement between the column tube and the vehicle body caused by the axial impact is configured to break down energy by chip removal.

DE 196 24 218 A1 shows a safety steering column with a column tube which is arranged concentrically to a steering spindle and is fastened to the vehicle body and which, during an axial impact action, can be shortened, while absorbing energy. At the same time, the column tube cooperates with at least one energy absorption element which in this case is designed as a corrugated tube.

WO 98/58831 describes a safety steering column with an associated energy absorption device, the energy absorption device being designed in the form of a chip removal element. In this case, a retainer of the column tube is mounted displaceably on a holder fixed to the body. Furthermore, a tubular body with grooves of different depths and also a cutting device are provided on this holder. In the event of a displacement of the retainer in relation to the holder, the cutting device is drawn into a groove of the tubular body via a pull element, while at the same time performing cutting work, and thus absorbs the impact energy of an occupant. The absorption capacity of the device is adapted by way of a controlled selection of a groove having an appropriate depth.

WO 01/03991 shows a safety steering column, in which chip removal elements are activated according to the load situation and which likewise absorb energy by the performance of cutting work.

### SUMMARY OF THE INVENTION

Against this background, an object of the invention is to provide a safety steering column which indicates an optimized possibility for energy absorption when the safety steering column is pushed together during an axial impaction action.

According to the invention, one or more chip removal elements are used as energy absorption elements between the column tube mounting fixed with respect to the vehicle and the column tube itself. In contrast to the prior art, the chip removal elements do not bring about energy absorption by overcoming pressing-in forces, but, instead, by forming work during chip removal. When, in the event of a frontal impact, an axial force acts on the safety steering column, the latter is pushed together in the axial direction as a result of the relative movement of the column tube with respect to its mounting which is fixed in relation to the vehicle. Owing to this relative movement, the chip removal elements work according to material arranged for them, so that energy is thus broken down when the safety steering column is pushed together.

As also occurs in the prior art, the chip removal elements may be adapted individually to the conditions of the respective safety steering column during assembly, for example by a selection of the size of the chip removal elements or the arrangement of these with respect to the chip removal cross section to be worked, so that the safety steering column can be designed optimally.

It is particularly advantageous to fasten the chip removal elements to the column tube or to the mounting fixed in relation to the vehicle, in such a way that it is possible to adapt the energy absorption, during travel, as a function of the current driving and/or driver parameters. Thus, for example, the weight of the driver can be determined by a suitable sensor technology and the chip removal elements can be set in such a way that, in the case of heavy drivers, a larger chip removal cross section is worked, that is to say more energy is also absorbed. Moreover, the vehicle speed, which is known in any case, can be utilized for regulating the energy absorption.

It is also contemplated to design the control as a function of other parameters which characterize the situation of the driver and of the vehicle, such as, for example, which sitting position the driver assumes, whether he is strapped in, what distance he is at from the steering wheel or which relative speed the vehicle has with respect to an obstacle, etc.

In one embodiment, the setting of the chip removal cross section worked by the chip removal elements can take place via regulation of the chip removal width. Of course, the chip removal cross section may also be varied via regulation of the chip removal depth, in that, for example, the inclination of the chip removal elements with respect to the material to be cut is made adjustable.

In order to set the chip removal width, two chip removal elements may be arranged mirror-symmetrically in each case on the outsides of the column tube and are mounted so as to be displaceable transversely to the axial extent of the column tube via a suitable drive means.

In order to make displacement possible, cutting plates, which are fastened in each case to a guide block, may be provided as chip removal elements. The cutting plates should be fastened to the guide block in such a way that, during the action of the axial impact force, they are not tilted out of place on the material to be worked.

The guide blocks may be guided in a groove running transversely to the axial extent of the column tube, thereby affording a simple and cost-effective possibility for setting the chip removal width. Insofar as the chip removal cross section is to be regulated via the chip removal depth, the guide blocks must be oriented differently.

In order to adapt the energy absorption capacity of the safety steering column to the respective driving or driver parameters during travel, the guide blocks are moveable in the groove of the column tube. Adaptation to the respective driving or driver situation may take place at intervals, that is to say not every brief change in the detected measurement values results in a regulation of the chip removal cross section.

An electric motor arranged between the guide blocks can receive a control pulse according to the measured driving or driver parameters and reduce or increase the distance between the guide blocks, for example via threaded rods, the chip removal width thereby being varied simultaneously, and can thus vary the energy absorption capacity of the safety steering column.

The material to be worked by the cutting plates may be made available as a chip removal rail to the cutting plates. The advantage of this is that the material, for example aluminum, of the chip removal rail is freely selectable and independent of the materials of the safety steering column. Of course, all other materials suitable for chip removal may also be used.

Depending on structural conditions, the chip removal rail may be fastened, fixedly in relation to the vehicle, to guide rails on which the column tube is mounted fixedly in relation to the vehicle. The necessary relative movement between the column tube and the mounting fixed in relation to the vehicle can thus be achieved in a simple way.

In order, during the action of the axial impact, to prevent an impact on the mutual cutting means, that is to say a blockage of or damage to the mutual cutting means, the chip removal rail may be provided with an indentation.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective cross section view through a safety steering column with an energy absorption element according to the present invention, and

FIG. 2 is an enlarged perspective view of an energy absorption element shown in FIG. 1.

### DETAILED DESCRIPTION OF THE DRAWINGS

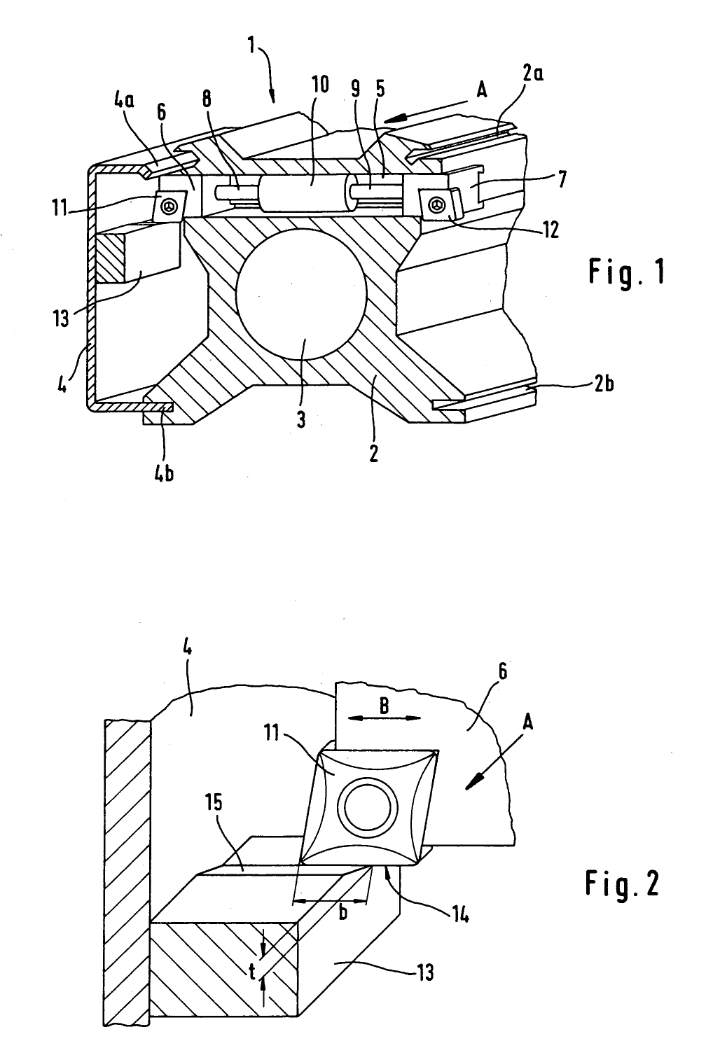

FIG. 1 shows a safety steering column 1 with a column tube 2. The column tube 2 has a cylindrical clearance 3 introduced there, in which clearance a conventional steering spindle, not illustrated, runs concentrically to the column tube 2 and is mounted rotatably in the latter. For normal operation, the column tube 2 is mounted on guide rails 4 fixedly in relation to the vehicle. In the event of an impact, the column tube 2 receives a momentum in the direction of the arrow A via the steering spindle acted upon by the impacting driver, with the direction of movement of the column tube 2 being predetermined by the orientation of the guide rails 4. The guide rails 4 have a U-shaped cross section and engage with their ends 4a, 4b into corresponding grooves 2a, 2b of the column tube 2.

For individual adaptation of the energy absorption when the column tube is pushed together in the event of an impact, a groove 5 is introduced transversely to the axial extent of the safety steering column 1. Two guide blocks 6, 7 are arranged displaceably in the groove mirror-symmetrically to the center axis of the column tube 2. Each guide block 6 or 7 is connected via a threaded rod 8 or 9 to an electric motor 10 likewise arranged in the groove 5. The electric motor 10 is activated via a conventional control and regulating unit, not illustrated, which evaluates the actual values of the travel and/or of the driver and delivers corresponding signals for setting the distance between the two guide blocks 6 and 7.

A cutting plate 11 or 12 is fastened to each guide block 6 or 7, each cutting plate 11 or 12 bearing against a chip removal rail 13 assigned to it. Only the chip removal rail 13 for the cutting plate 11 is illustrated in FIG. 1 for the sake of clarity.

As may be gathered particularly from the enlarged illustration of the cutting plate 11 in FIG. 2, the cutting plate 11 bears with its cutting edge 14 against the chip removal rail 13 with a chip removal width b. In order to avoid blockage between the cutting plates 11 and the chip removal rail 13 during impact, the chip removal rail 13 is provided with an indentation 15.

Since the guide block 6 can be moved back and forth in the direction of the arrow B by the electric motor 10, a wider or narrower overlap of the cutting edge 14 with the chip removal rail 13 can be achieved. The change in the chip removal cross section which follows as a result gives rise to a change in the counterforce which counteracts the cutting plate 11 when the column tube 10 runs forward and therefore to a change in the energy absorption of the system as a whole. It is conventional, in addition to the adaptation of the energy absorption via the setting of the chip removal width b, also to adapt the energy absorption via the setting of the chip removal depth t, for example by way of a pivotable or vertically adjustable arrangement of the cutting plates 6 and 7.

Accordingly, via the distance between the cutting plates 6 and 7, the crash behavior of the safety steering column can be adapted at short intervals to the respective driving situation, for example accident speed, acceleration values or seat setting, or to the respective driver, for example weight or size of the driver.

Depending on the requirement to be met by the safety steering column, a plurality of cutting plates may be arranged on each side over the length of the column tube. It is also contemplated to accommodate two further cutting plates on the other side of the cylindrical clearance 3 in a second groove of the column tube.

It is in this case unimportant for complementation of the present invention whether the chip removal elements or the chip removal rail are moved together with the column tube. That is, it is also contemplated to fasten the chip removal elements 11, 12 to the guide rails 4 and the chip removal rail 13 to the column tube 2 and to regulate them correspondingly. The chip removal rails can even be dispersed with, so as to cut suitable edges of the steering column, for example by way of chip removal elements fastened to the guide rails, a column tube manufactured, for example from aluminum and having a suitable chip removal edge.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (Cancelled)

11. A safety steering column for a motor vehicle, comprising a column tube arranged concentrically to a steering spindle and operatively connected to the vehicle body to be shortenable during an axial impact while absorbing energy, and at least one energy absorption element operatively cooperating with the column tube, the at least one energy absorption element being at least one of chip removal element which, in the event of relative movement between the column tube and the vehicle body caused by the axial impact is configured to break down energy by chip removal, wherein a chip removal cross section to be worked by the at least one chip removal element is settable, with adaptation of the energy absorption during travel, as a function of at least one of current driving and driver parameters.

12. The safety steering column as claimed in claim 11, wherein setting of the chip removal cross section is effective via a change in chip removal width.

13. The steering column arrangement as claimed in claim 11, wherein the at least one chip removal element comprises two chip removal elements arranged mirror symmetrically outwardly of the column tube.

14. The steering column arrangement as claimed in claim 13, wherein setting of the chip removal cross section is effected via a change in chip removal width.

15. The steering column arrangement as claimed in claim 11, wherein the at least one chip removal element is at least one cutting plates fastenable at least one guide block.

16. The steering column arrangement as claimed in claim 15, wherein setting of the chip removal cross section is effected via a change in chip removal width.

17. The steering column arrangement as claimed in claim 16, wherein the at least one chip removal element comprises two chip removal elements arranged mirro-symmetrically outwardly of the column tube.

18. The steering column arrangement as claimed in claim 15, wherein the guide block is guided in a groove running transversely to a center axis of the column tube.

19. The steering column arrangement as claimed in claim 16, wherein the at least one guide block is moveable in the groove of the column tube such that the chip removal width is settable for the at least one cutting plate.

20. The steering column arrangement as claimed in claim 19, wherein the at least one guide block comprises plural guide blocks and movement of the guide blocks takes place via an electric motor arranged centrally between the guide blocks (.

21. The steering column arrangement as claimed in claim 20, wherein the at least one cutting plate bears against a respective chip removal rail produced as cutting material.

22. The steering column arrangement as claimed in claim 21, wherein the chip removal rail is fastened to guide rails which are fixed in relation to the motor vehicle and via which the fastening of the column tube to the vehicle body takes place.

23. The steering column arrangement as claimed in claim 21, wherein the chip removal rail has an indentation.

24. The steering column arrangement as claimed in claim 23, wherein the chip removal rail is fastened to guide rails which are fixed in relation to the motor vehicle and via which the fastening of the column tube to the vehicle body takes place.
